(19) United States
(12) Patent Application Publication
(10) Pub. No.: US 2005/0240686 A1
(43) Pub. Date: Oct. 27, 2005

(54) Method for downloading firmware of peripheral equipment, and peripheral equipment

(75) Inventor: Goichi Kashiwagi, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 10/978,746

(22) Filed: Nov. 1, 2004

(30) Foreign Application Priority Data
Apr. 23, 2004 (JP) 2004-128159

(51) Int. Cl. G06F 13/12

(52) U.S. Cl. 710/8

(57) ABSTRACT

An upper-level equipment download firmware to a peripheral equipment while information having been set from the upper-level equipment is inherited after downloading. The peripheral equipment includes a controller for controlling the peripheral equipment through the execution of firmware and nonvolatile memories for storing information for the controller. The controller receives the firmware from upper-level equipment, and preserves in the nonvolatile memories the information set from the upper-level equipment to the peripheral equipment. At the time of initializing the peripheral equipment after receiving the firmware, the controller reads out the set information preserved in the nonvolatile memories, and resets the set information to the peripheral equipment.

### CROSS-REFERENCE TO RELATED APPLICATIONS

This application is based upon and claims the benefit of priority from the prior Japanese Patent Application No. 2004-128159, filed on Apr. 23, 2004, the entire contents of which are incorporated herein by reference.

### BACKGROUND OF THE INVENTION

1. Field of the invention

This invention relates to a method for downloading firmware of a peripheral equipment externally in the event of a failure in the peripheral equipment or when upgrading the firmware, and peripheral equipment using the same, and more particularly a firmware downloading method and peripheral equipment for avoiding any influence on subsequent operation of the Operating System (OS), even if the firmware is downloaded while the OS is working in upper-layer equipment.

2. Description of the related art

With advanced data processing techniques in recent years, in a peripheral equipment, such as a magnetic disk drive, the number of an equipment being provided with a processor(s) and operated by a firmware program have increased. Such firmware has to be modified when a failure occurred caused by the firmware, or when the firmware version has to be upgraded. It is effective to download the firmware for firmware modification, similar to the case of program installation, as disclosed in the Japanese Laid-open Patent Publication No. Hei-6-012348.

However, since the firmware fundamentally controls peripheral equipment hardware, it becomes necessary to devise a means different from the case of downloading an ordinary program. For example, assume a case of necessary modification of the firmware of a magnetic disk drive, as one type of peripheral equipment, at the customer's site.

Conventionally in such a case, for example, the following method has been applied: The magnetic disk drive is dynamically extracted from the working system (which is termed active maintenance), and then the magnetic disk drive is replaced to another drive. Or, after extracting the magnetic disk drive, firmware is downloaded to the magnetic disk drive concerned, and thereafter the magnetic disk drive is connected again to the system.

Since the active maintenance function is a particular function provided on the system side, the function is adopted mostly in a large-scale storage system or server system. In contrast, in a system having no active maintenance function, operation of the system is halted once, and new firmware is downloaded to the magnetic disk drive connected in the system, using a particular tool prepared by the vendor.

Namely, when downloading firmware to the magnetic disk drive, memory allocation being used is different depending on the program to be downloaded. Therefore, on completion of the download, usually boot processing is performed in a similar way to the power-on procedure.

As a result of the download, various settings relating to the status in the magnetic disk drive which are set in a system environment before the download are initialized. Therefore, when firmware modification on the customer site becomes necessary, generally, a tool (device) prepared peculiar to the vender is used.

In this case, in order to inhibit any disk access other than the purpose for downloading the firmware, the OS operated in the upper-level equipment must be halted once.

However, in system environments for some user, for example, requiring 24-hour operation, it is not desirable to halt the OS in the upper-level equipment.

Also, in recent years, a large amount of the peripheral equipment sets such as the magnetic disk drives with advanced functions have been manufactured. To support the users of the magnetic disk drives, it is becoming necessary to incorporate the capability of downloading and updating the magnetic disk drive firmware without using any special tool, in each use environment of the user.

### SUMMARY OF THE INVENTION

Accordingly, it is an object of the present invention to provide a method for downloading the firmware of the peripheral equipment, and peripheral equipment, enabling firmware downloading without removing the peripheral equipment from the system environment, even in a system having no support capability of active maintenance.

It is another object of the present invention to provide a method for downloading the firmware of the peripheral equipment, and the peripheral equipment, enabling firmware downloading without using a special tool in the use environment of the user.

It is still another object of the present invention to provide a method for downloading the firmware of the peripheral equipment, and peripheral equipment, enabling inherited use of various settings having been set in the system environment before downloading the firmware successively after the download, without using a special tool, in the use environment of the user.

In order to achieve the objects, according to the present invention, there is disclosed a method of downloading, from upper-level equipment, the firmware of peripheral equipment connected to the upper-level equipment. The method includes the steps of: receiving the firmware from the upper-level equipment; preserving in a nonvolatile storage the information set from the upper-level equipment to the peripheral equipment; and when initializing the peripheral equipment after the download, resetting the set information to the peripheral equipment after reading out the set information preserved in the nonvolatile storage.

Further, according to the present invention, there is disclosed peripheral equipment connected to the upper-level equipment, performing operation corresponding to a command from the upper-level equipment. The peripheral equipment includes: an interface controller controlling interface to the upper-level equipment; a controller performing control of the peripheral equipment by executing the firmware; and a nonvolatile storage storing information for the controller. The controller receives the firmware from the upper-level equipment, preserves in the nonvolatile storage the information set from the upper-level equipment to the peripheral equipment, reads out the set information preserved in the nonvolatile storage at the time of initialization of the peripheral equipment after receiving the firmware and resets the information to the peripheral equipment.

Still further, according to the present invention, preferably, the preservation step preserves the set information in a storage disk of a disk drive, one type of the peripheral equipment.

Further, according to the present invention, preferably, the method further includes the step of deciding whether or not resetting the set information is to be performed at the time of initialization of the peripheral equipment.

According to the present invention, preferably, the preservation step is a step of preserving the set information in the nonvolatile memory of the peripheral equipment.

According to the present invention, preferably, the reception step includes the step of receiving a download command and the firmware from the upper-level equipment, and the preservation step is executed by the download command.

According to the present invention, preferably, the decision step includes the step of deciding based on whether or not a reset command is received from the upper-level equipment.

According to the present invention, preferably, the decision step includes the step of deciding based on reset control information set in the peripheral equipment.

Further, according to the present invention, preferably, the preservation step includes the step of preserving the set information which determines an operation mode of the peripheral equipment specified by each command issued from the OS in the upper-level equipment.

Further scopes and features of the present invention will become more apparent by the following description of the embodiments with the accompanied drawings.

### BRIEF DESCRIPTION OF THE DRAWINGS

FIG. 1 shows a configuration diagram of peripheral equipment according to one embodiment of the present invention.

FIG. 2 shows a system configuration using the peripheral equipment shown in FIG. 1.

FIG. 3 shows a memory map of the peripheral equipment shown in FIG. 1.

FIG. 4 shows an explanation diagram of the set parameters of the peripheral equipment shown in FIG. 1.

FIG. 5 shows an explanation diagram of the firmware to be downloaded to the peripheral equipment shown in FIG. 1.

FIG. 6 shows a flowchart of firmware download processing according to one embodiment of the present invention.

FIG. 7 shows an explanation diagram of the download processing according to one embodiment of the present invention.

FIG. 8 shows a flowchart of firmware download processing according to another embodiment of the present invention.

FIG. 9 shows a system configuration according to another embodiment of the present invention.

### DETAILED DESCRIPTION OF THE PREFERRED EMBODIMENTS

The preferred embodiment of the present invention is described hereinafter referring to the charts and drawings, on the order of peripheral equipment, firmware download processing, and other preferred embodiments. However, it is noted that the scope of the present invention is not limited to the embodiments described below.

Peripheral Equipment

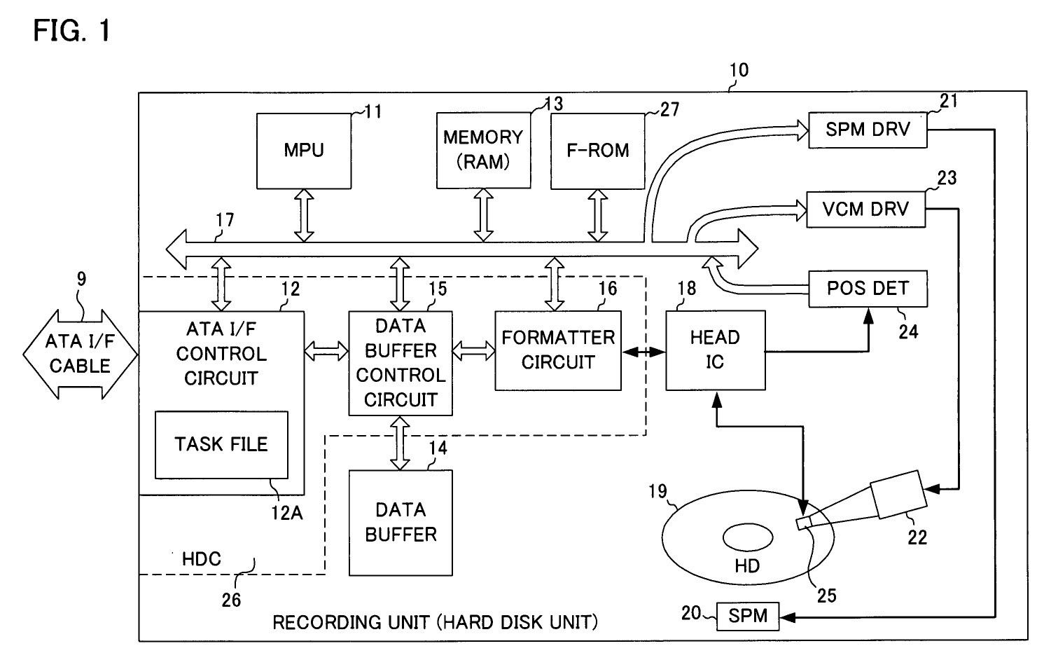

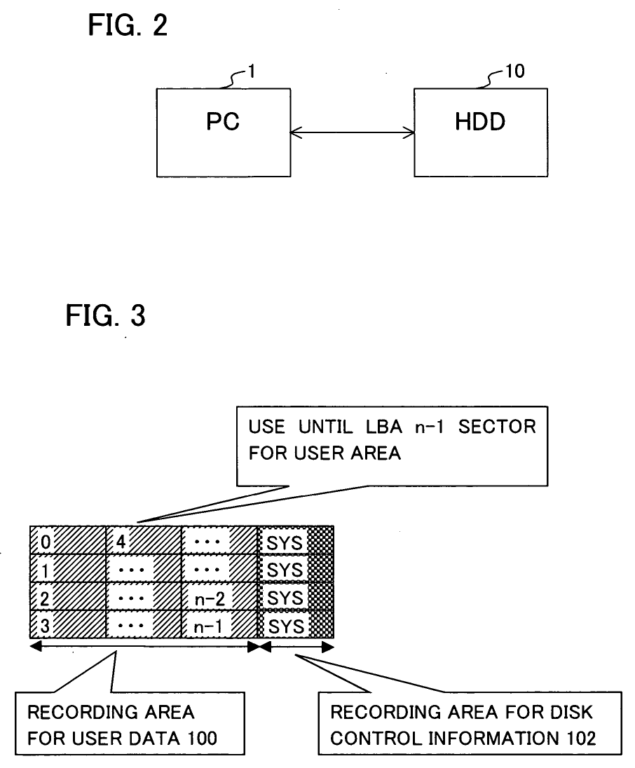

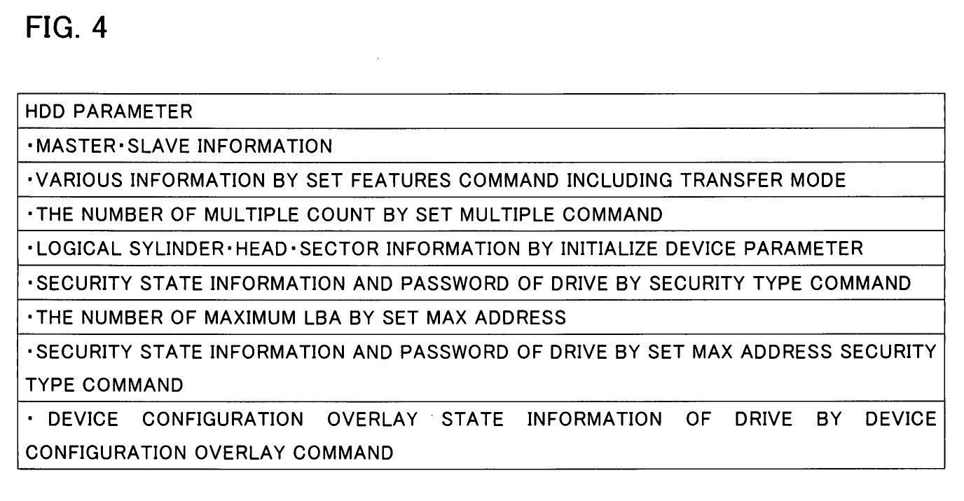

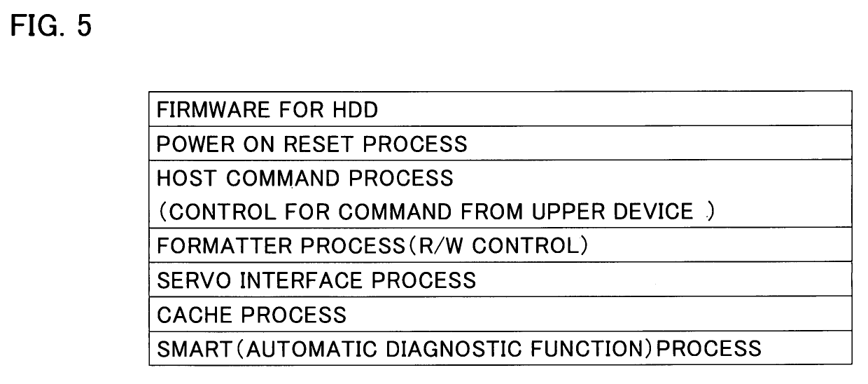

FIG. 1 shows a configuration diagram of peripheral equipment according to one embodiment of the present invention. FIG. 2 shows a system configuration using the peripheral equipment shown in FIG. 1. Also, FIG. 3 shows a memory map of the peripheral equipment shown in FIG. 1. FIG. 4 shows an explanation diagram of the set parameters of the peripheral equipment shown in FIG. 1. Further, FIG. 5 shows an explanation diagram of the firmware to be downloaded to the peripheral equipment shown in FIG. 1.

In FIG. 1, as an example of the peripheral equipment, a magnetic disk drive (HDD), which is a media storage unit for reading/writing data from/to a magnetic disk, is shown. A magnetic disk drive 10 is connected to a host 1 such as personal computer, with a cable 9 having the interface conforming to the ATA (AT Attachment) standard.

As shown in FIG. 1, the magnetic disk drive 10 includes a magnetic disk 19; a spindle motor 20 for rotating the magnetic disk 19; a magnetic head 25 for reading data from the magnetic disk 19, and writing data on the magnetic disk 19; and an actuator (VCM) 22 for moving the magnetic head 25 in the radius (cross-track) direction of the magnetic disk 19.

Further, as controller, HDC (hard disk controller) 26, a data buffer 14, MPU (Microprocessor) 11, memory (RAM) 13, a nonvolatile memory (F-ROM) 27, a head IC 18, a spindle motor driver 21, a VCM driver 23, a position detector 24 are provided, as well as bus 17 for connecting the above portions.

HDC 26 further includes an ATA interface (I/F) control circuit 12 having a task file 12A into which tasks are set from the host, a data buffer control circuit 15 for controlling the data buffer 14, and a formatter control circuit 16 for controlling a record data format.

In write operation, the head IC 18 makes a record current flow to the magnetic head 25 according to a record data. Also, in read operation, the head IC 18 amplifies a read signal from the magnetic head 25 and outputs a read data (including servo information). The position detector 24 detects the position of the magnetic head 25 using the servo information fed from the head IC 18.

The spindle driver 21 drives the spindle motor 20 to rotate. The VCM driver 23 drives the VCM 22 for moving the magnetic head 25.MPU (microprocessor) 11 performs position control, read/write control, and retry control of the magnetic head 25. The memory (RAM) 13 stores data necessary for the processing in MPU 11. The nonvolatile memory 27 stores processing program of MPU 11, as well as firmware.

FIG. 3 shows an explanation diagram of a data area in the magnetic disk drive 10. The data area is divided into a user data area (LBA0 to LBAn-1) 100 accessible from a user, and a system area 102 other than the user data area. The system area 102 stores information necessary for controlling the magnetic disk drive 10, including defective sector position information on the medium of magnetic disk 19.

This system area 102 is not directly accessible from the magnetic disk user. Within this area, there is provided an area for preserving/recording each volatile parameter which is set to the magnetic disk drive 10 by the ATA commands issued from the upper-level equipment 1.

The magnetic disk drive has information, so-called volatile information, of which set data are lost by switching the power on or off, or by hardware reset operation. As shown in FIG. 4, the set parameters among the above information include master/slave information, various settings including a transfer mode, set by Set Features Command, the number of multiple counts by Set Multiple Mode Command, logical cylinder/head/sector information by Initialize Device Parameter Command, Security state information and a password of the drive by the Security type commands, the maximum number of LBA (logical block addresses) by Set Max Address, Set Max Security state information and the password of the drive by Set Max Address Security type commands, and Device Configuration Overlay state information of the drive by Device Configuration Overlay Command.

Meanwhile, as shown in FIG. 5, the firmware to be downloaded includes Power-on reset process, Host command process (control against commands issued from the upper-level equipment), Formatter process (read/write operation), Servo interface process, Cache process, and Automatic diagnosis process. Here, mainly data-related processing of magnetic disk drive 10 is shown.

As to the firmware download function to the magnetic disk drive, the memory allocation being used differs depending on the programs to be downloaded. Therefore, conventionally, boot processing similar to the power-on has been performed after the download.

Also, according to the ATA standard, Download Microcode Command is provided, which can also be issued from the OS. However, when the firmware is downloaded by issuing this command, the parameters having been set before the download are lost, as described earlier.

To prevent loss of the parameters, according to the present invention, the parameters having been set by the OS are once preserved in a nonvolatile memory, and the preserved set parameters are read out and reset during the boot processing, as described in the following.

Firmware Download Processing

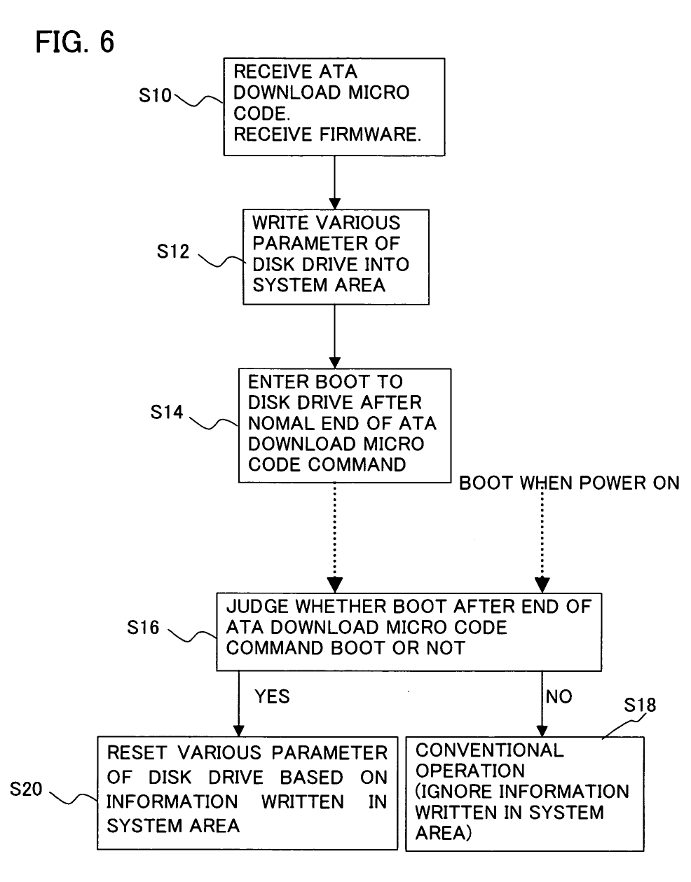

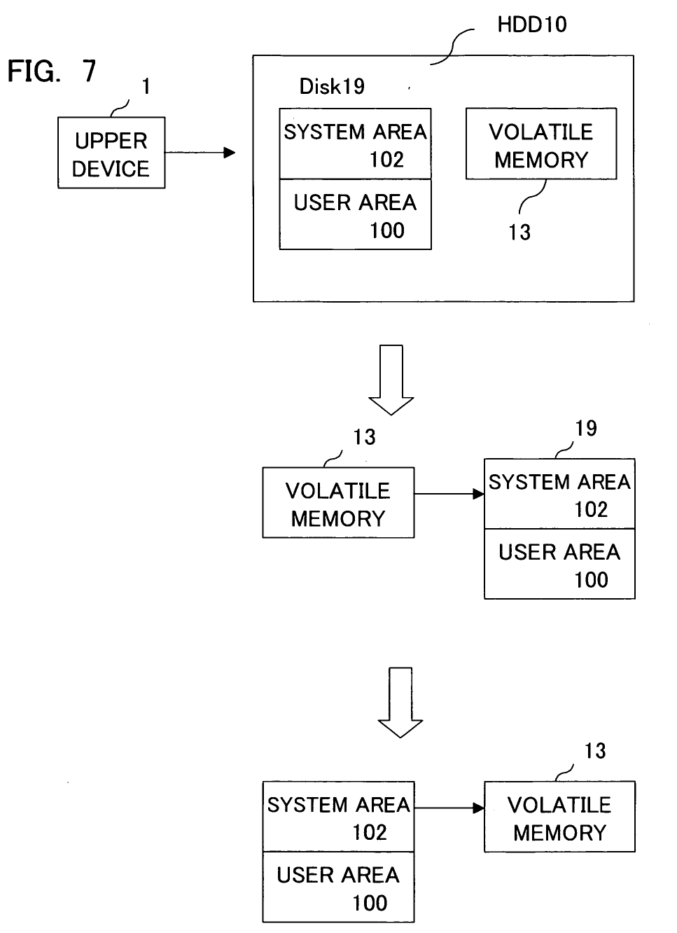

FIG. 6 shows a flowchart of firmware download processing according to one embodiment of the present invention. Also, FIG. 7 shows an explanation diagram of the operation of the above download processing. In the following description, the processing shown in FIG. 6 will be explained referring to FIG. 1 and FIG. 7.

(S10) The host system 1 downloads necessary firmware by issuing the ATA Download Microcode Command to the magnetic disk drive 10. ATA I/F control circuit 12 in the magnetic disk drive 10 receives the command and the firmware, and stores into the task file 12A.

(S12) ATA I/F control circuit 12 analyzes this command, and issues a preservation command to MPU 11. As shown in FIG. 7, MPU 11 preserves the aforementioned set parameters stored in RAM 13 into the system area 102 (here, the system area is provided in magnetic disk 19).

(S14) ATA I/F control circuit 12 stores the firmware downloaded to the magnetic disk drive 10 to the nonvolatile memory 27, and sends a response of normal completion to the host 1. The magnetic disk drive 10 is then shifted to the boot processing.

(S16) Here, MPU 11 decides whether the boot is initiated by the ATA Download Microcode Command, or by the power switched on.

(S18) When MPU 11 decides that the boot is not caused by the execution of the ATA Download Microcode Command, but by the normal power on, the conventional boot operation is performed. In this case, the aforementioned information stored in the system area 102 is ignored.

(S20) Meanwhile, when MPU 11 decides the boot is caused by the execution of the ATA Download Microcode Command, as shown in FIG. 7, MPU 11 sets various parameters based on the information stored in the aforementioned system area 102, so that the parameters become identical to those before the ATA Download Microcode Command was issued. Namely, MPU 11 stores the set parameters in the system area 102 into a specified area in RAM 13.

As such, the information set by the ATA commands before the download is maintained after the download, based on the information having been written in the system area 102. Thus, the magnetic disk drive condition becomes identical to the condition before the ATA Download Microcode Command is issued. Accordingly, the relation between the OS in the upper-level equipment 1 and the magnetic disk drive 10 is not changed before and after the ATA Download Microcode Command is issued.

Additionally, as to a means to restore the magnetic disk drive condition to the condition before the download, it is not necessary to issue an additional command from the host 1, because the magnetic disk drive automatically restored its own condition at the time of downloading.

Other Preferred Embodiments

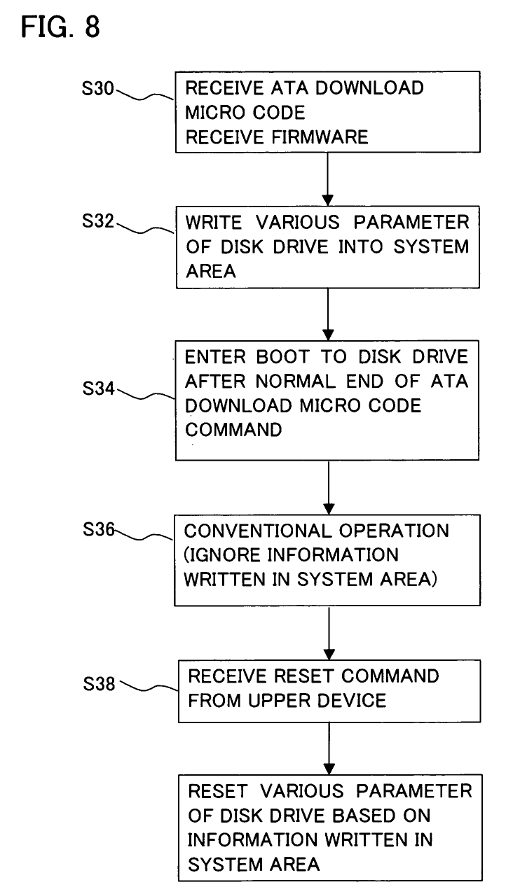

FIG. 8 shows a flowchart of firmware download processing according to another embodiment of the present invention.

According to this embodiment, a reset command is issued from the host 1 when necessary, and thus reset control is enabled on the host 1 side. In the following, the process will be described referring to FIG. 8.

(S30) The host system 1 downloads necessary firmware to the magnetic disk drive 10 by issuing the ATA Download Microcode Command. On receipt of the command and the firmware, ATA I/F control circuit 12 in the magnetic disk drive 10 stores the command and the firmware into the task file 12A.

(S32) ATA I/F control circuit 12 then analyzes the command, and issues a preservation command to MPU 11. As shown in FIG. 7, MPU 11 preserves the aforementioned set parameters stored in RAM 13 into the system area 102 (here, the system area provided in the magnetic disk 19).

(S34) ATA I/F control circuit 12 stores, into the nonvolatile memory 27, the firmware downloaded to the magnetic disk drive 10, and sends a reply of normal completion to the host 1.

(S36) Thereafter, MPU 11 executes boot processing of the magnetic disk. In this case, the aforementioned information stored in the system area 102 is ignored.

(S38) Meanwhile, the host 1 issues a reset command to the magnetic disk drive 10 when it is necessary to reset. ATA I/F control circuit 12 in the magnetic disk drive 10 receives this command, analyzes the command, and issues a preservation command to MPU 11. As shown in FIG. 7, MPU 11 sets various parameters based on the information having been written in the aforementioned system area 102, so that the condition becomes identical to the condition before the issue of the ATA Download Microcode Command. Namely, MPU 11 stores the set parameters in the system area 102 into a specified area in RAM 13.

As such, the information having been set by the ATA command before the download is maintained after the download, based on the information written in the system area 102. Thus, the magnetic disk drive condition becomes identical to the condition before the issue of the ATA Download Microcode Command. Accordingly, the relation between the OS in the upper-level equipment 1 and magnetic disk drive 10 is not changed before and after the ATA Download Microcode Command is issued. Further, the reset operation is controlled on the host side. When the host decides resetting is not needed, the reset operation can be avoided.

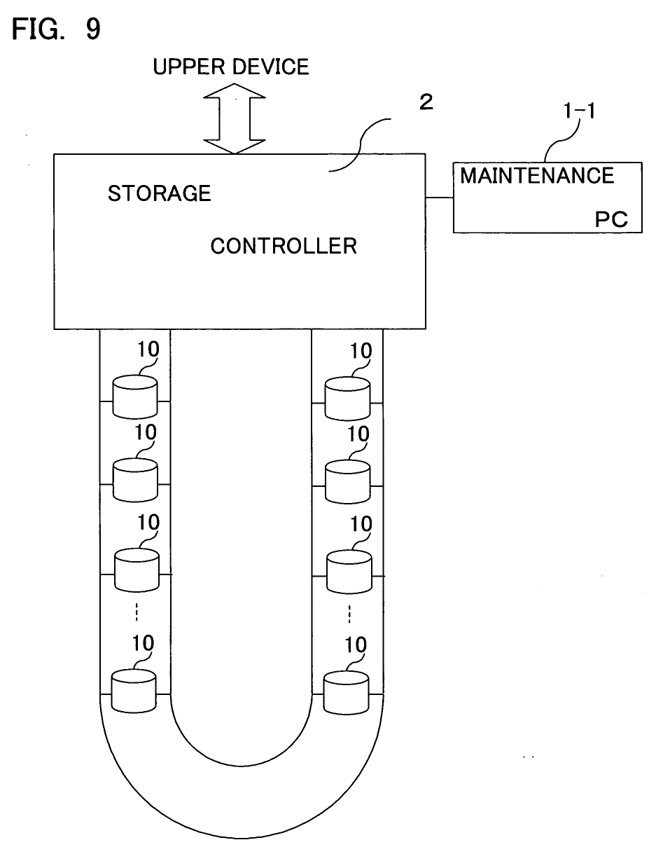

Now, FIG. 9 shows a system configuration according to another embodiment of the present invention, in which a storage system is illustrated. As shown in FIG. 9, a multiple of magnetic disk drives 10 are connected to a disk controller 2. The disk controller 2 performs read/write processing by accessing the magnetic disk drives 10, according to the access command sent from the upper-level equipment (host). For example, using a plurality of magnetic disk drives, RAID (redundant array of independent disks) is structured.

To this disk controller 2, a maintenance personal computer 1-1 is connected, which performs various settings, operation supervision, debugging, etc, to the disk controller 2. In this example, the firmware is downloaded from this maintenance personal computer 1-1 to a desired magnetic disk drive 10.

In this case also, in the same way as described above, the information set by the ATA command before downloading to the magnetic disk drive is maintained after the download, based on the information written in the system area 102. Accordingly, the condition of the magnetic disk drive is identical to the condition before the ATA Download Microcode Command was issued.

In the above-mentioned other embodiment of the present invention, resetting is performed on receipt of the reset command from the host 1. However, it may be possible to set control information indicative of whether resetting be performed in either one of the system area and the nonvolatile memory in the magnetic disk drive, and to decide whether or not the resetting be performed based on this information.

Also, as peripheral equipment, the magnetic disk drive is exemplified in the above description. However, the present invention is applicable to any other storage devices such as optical disks, optical magnetic disks and other storage devices using different storage media. Moreover, the present invention is applicable to other peripheral equipment such as other memory devices, printers, image processors, which are operated by the OS in the upper-level equipment.

Further, the interface may not be limited to ATA. The present invention is also applicable to other interfaces. Although the set parameters are preserved in the system area of the disk 19 in the above description, the set parameters may be preserved in the nonvolatile memory 27. Also, although the magnetic disk drive is provided outside the host, the magnetic disk drive may be incorporated in the host.

According to the present invention, the information having been set in the peripheral equipment by the commands from the upper-level equipment is preserved in the nonvolatile memory. By reading out this information and resetting the information to the peripheral equipment, the set parameters are maintained even after the download of the firmware. Therefore, the peripheral equipment condition is not changed between before and after the download.

Accordingly, undesirable influence to the relation with the system OS is avoidable, and after the download, the system can continue operation as before. Further, an application for updating firmware of the peripheral equipment can be provided to the OS, which is effective for maintaining quality of the peripheral equipment.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

1. A method of downloading firmware of a peripheral equipment for downloading from an upper-level equipment the firmware of the peripheral equipment connected to the upper-level equipment, comprising the steps of:
receiving the firmware from the upper-level equipment;
preserving in a nonvolatile storage the information having set from the upper-level equipment to the peripheral equipment; and
resetting the set information to the peripheral equipment after reading out the set information preserved in the nonvolatile storage when initializing the peripheral equipment after the download,.

2. The method of downloading firmware of peripheral equipment according to claim 1,
wherein the preservation step comprises a step of preserving the set information in a storage disk of a disk drive, one type of the peripheral equipment.

3. The method of downloading firmware of peripheral equipment according to claim 1, further comprising a step of deciding whether or not resetting the set information is to be performed at the time of initialization of the peripheral equipment.

4. The method of downloading firmware of peripheral equipment according to claim 1,
wherein the preservation step comprises a step of preserving the set information in the nonvolatile memory of the peripheral equipment.

5. The method of downloading firmware of peripheral equipment according to claim 1,
wherein the reception step comprises a step of receiving a download command and the firmware from the upper-level equipment, and the preservation step is executed by the download command.

6. The method of downloading firmware of peripheral equipment according to claim 3,
wherein the decision step comprises a step of deciding based on whether or not a reset command is received from the upper-level equipment.

7. The method of downloading firmware of peripheral equipment according to claim 3,
wherein the decision step comprises a step of deciding based on reset control information set in the peripheral equipment.

8. The method of downloading firmware of peripheral equipment according to claim 1,
wherein the preservation step comprises a step of preserving the set information which determines an operation mode of the peripheral equipment specified by each command issued from OS in the upper-level equipment.

9. A peripheral equipment connected to upper-level equipment and performing operation corresponding to a command from the upper-level equipment, comprising:
an interface controller for controlling interface to the upper-level equipment;
a controller for performing control of the peripheral equipment by executing firmware; and
a nonvolatile storage for storing information for the controller,
wherein the controller receives the firmware from the upper-level equipment, preserves in the nonvolatile storage the information set from the upper-level equipment to the peripheral equipment, reads out the set information preserved in the nonvolatile storage at the time of initialization of the peripheral equipment after receiving the firmware and resets the information to the peripheral equipment.

10. The peripheral equipment according to claim 9,
wherein the controller preserves the set information in a storage disk of a disk drive, one type of the peripheral equipment.

11. The peripheral equipment according to claim 9,
wherein the controller decides whether or not resetting the set information is to be performed at the time of initialization of the peripheral equipment.

12. The peripheral equipment according to claim 9,
wherein the controller preserves the set information in a nonvolatile memory, being used as nonvolatile storage, of the peripheral equipment.

13. The peripheral equipment according to claim 9,
wherein the interface controller receives a download command and the firmware from the upper-level equipment, and makes the controller to execute the preservation operation.

14. The peripheral equipment according to claim 11,
wherein the controller decides to perform resetting based on whether or not a reset command is received from the upper-level equipment.

15. The peripheral equipment according to claim 11,
wherein the controller decides to perform resetting based on reset control information set in the peripheral equipment.

16. The peripheral equipment according to claim 9,
wherein the controller preserves the set information which determines an operation mode of the peripheral equipment specified by each command issued from OS in the upper-level equipment.

17. The peripheral equipment according to claim 9, further comprising:
a storage disk;
a head for reading out at least information stored in the storage disk;
an actuator for positioning the head to a desired position of the storage disk; and
a drive circuit controlled by the controller.
